(19) United States
(12) Patent Application Publication
(10) Pub. No.: US 2024/0289168 A1
(43) Pub. Date: Aug. 29, 2024

(54) PROGRAMMABLE LOOK UP TABLE FREE HARDWARE ACCELERATOR AND INSTRUCTION SET ARCHITECTURE FOR ACTIVATION FUNCTIONS

(71) Applicant: Intel Corporation, Santa Clara, CA (US)

(72) Inventors: Krishnan Ananthanarayanan, Kerala (IN); Martin Langhammer, Alderbury (GB); Om Ji Omer, Bangalore (IN); Bogdan Pasca, Toulouse (FR); Kamlesh Pillai, Bangalore (IN); Pramod Udupa, Bangalore (IN)

(21) Appl. No.: 18/506,687

(22) Filed: Nov. 10, 2023

(51) Int. Cl. G06F 9/50

(52) U.S. Cl. CPC G06F 9/5027

(57) ABSTRACT

Systems, apparatuses and methods may provide for technology that identifies a type of a first activation function, identifies a derivative level of the first activation function, and generates a first instruction based on the type of the first activation function and the derivative level of the first activation function. The technology also includes an accelerator having logic coupled to one or more substrates, the logic including a compute engine including a plurality of arithmetic operators, a multiplexer network coupled to the compute engine, and a controller coupled to the multiplexer network, the controller to detect the first instruction, decode the first instruction to identify the first activation function, and drive the multiplexer network to form first connections between two or more of the plurality of arithmetic operators in accordance with the first activation function, wherein the first connections are to cause the compute engine to conduct the first activation function.

### TECHNICAL FIELD

Embodiments generally relate to artificial intelligence (AI) activation functions. More particularly, embodiments relate to a programmable look up table (LUT) free hardware accelerator and instruction set architecture (ISA) for activation functions.

### BACKGROUND

With a growing demand for artificial intelligence (AI) capabilities across a variety of applications, supporting hardware architectures may be expected to be more power-efficient, cost-effective, and capable of meeting latency and throughput constraints. Though “multiply and accumulate” (MAC) is the most fundamental operator in AI and/or deep neural network (DNN) based methods, the choice of activation function may play a vital role in the efficacy of the deployed DNN model. An activation function of a node in an artificial neural network is a function that calculates the output of the node (e.g., based on inputs to the node and weights on individual inputs).

In a lookup table (LUT) based approach, the input data range of the activation function may be divided into multiple segments, and polynomial equations (e.g., first order, second order, etc.) may be used to fit the given segment. Challenges of the LUT based approach are relatively high storage area, access latencies associated with the location of the LUT, and increased cost associated with multi-ported LUTs to support sharing across multiple channels (e.g., single instruction multiple data/SIMD channels).

In another approach, a given activation function may be approximated (e.g., Taylor series expansion) and expressed in the form of a linear combination of multiple fundamental expressions (e.g., polynomial terms with respective coefficients). Challenges of the conventional approximation approach are accuracy loss and implementation complexity.

### BRIEF DESCRIPTION OF THE DRAWINGS

The various advantages of the embodiments will become apparent to one skilled in the art by reading the following specification and appended claims, and by referencing the following drawings, in which:

FIG. 1 is a comparative block diagram of an example of a conventional lookup table (LUT) based hardware implementation and an enhanced hardware accelerator according to an embodiment;

FIG. 2 is a more detailed block diagram of an example of an enhanced hardware accelerator according to an embodiment;

FIG. 3 is an illustration of an example of a table of a set of activation functions according to an embodiment;

FIG. 4 is an illustration of an example of a table of bypass and saturation region settings according to an embodiment;

FIG. 5 is a schematic diagram of an example of a multiplexer network according to an embodiment;

FIGS. 6-8 are illustrations of examples of tables of micro-code for various activation functions according to embodiments;

FIG. 9 is a block diagram of an example of bypass and saturation hardware and pipeline stages of a compute engine according to an embodiment;

FIG. 10A is an illustration of an example of a parallel instruction sequence according to an embodiment;

FIG. 10B is an illustration of an example of a sequential instruction sequence according to an embodiment;

FIG. 11 is a flowchart of an example of a method of issuing activation function instructions according to an embodiment;

FIGS. 12A and 12B are flowcharts of examples of methods of handling activation function instructions according to an embodiment;

FIG. 12C is a flowchart of an example of a method of operating a memory device according to an embodiment;

FIG. 12D is a flowchart of an example of a method of handling potential conflicts between sets of micro-code according to an embodiment;

FIG. 12E is a flowchart of an example of a method of operating bypass hardware and saturation hardware according to an embodiment;

FIG. 13 is a block diagram of an example of a performance-enhanced computing system according to an embodiment;

FIG. 14 is an illustration of an example of a semiconductor package apparatus according to an embodiment;

FIG. 15 is a block diagram of an example of a processor according to an embodiment; and

FIG. 16 is a block diagram of an example of a multi-processor based computing system according to an embodiment.

### DETAILED DESCRIPTION

As already noted, an activation function of a node in an artificial neural network is a function that calculates the output of the node (e.g., based on inputs to the node and weights on individual inputs). Often, a specific activation function is selected per class of artificial intelligence (AI) task. To cater to a variety of AI applications and a constantly evolving set of deep neural network (DNN) models, generic support of a wide range of activation functions is more advantageous than a finite set of functions.

Although highly programmable compute cores such as central processing units (CPUs, e.g., host processors) and graphics processing units (GPUs) can support different types of activation functions, these programmable compute cores may introduce performance bottlenecks and power inefficiencies when multiply and accumulate (MAC) operators are accelerated through specialized engines due to unbalanced bandwidth and compute throughput constraints. To address these concerns, in-situ (e.g., with MAC engines) fixed function support has been considered. Solution approaches such as look up table (LUT) based first or second order piece-wise approximation attempts to provide generic support for a range of activation functions, but for complex functions (e.g., Swish, Gelu, etc.) LUT solutions impose a trade-off between accuracy and storage area (e.g., for look-up tables) with a super-linear relationship. Accordingly, LUT solutions may not be suitable for high/medium precision compute applications.

The technology described herein includes a software programmable, LUT free hardware accelerator capable of supporting a wide range of current and future activation functions by decomposing the activation functions into a finite set of basic fundamental arithmetic operators and efficiently executing the arithmetic operators on respective compute units. The absence of a costly frontend decoder and complex register file multiplexer structure (e.g., as compared to CPU/GPU-based implementations) ensures fixed-function-like area and power efficiency while providing unprecedented programmability with high-precision compute (e.g., as compared to fixed-function-based implementations).

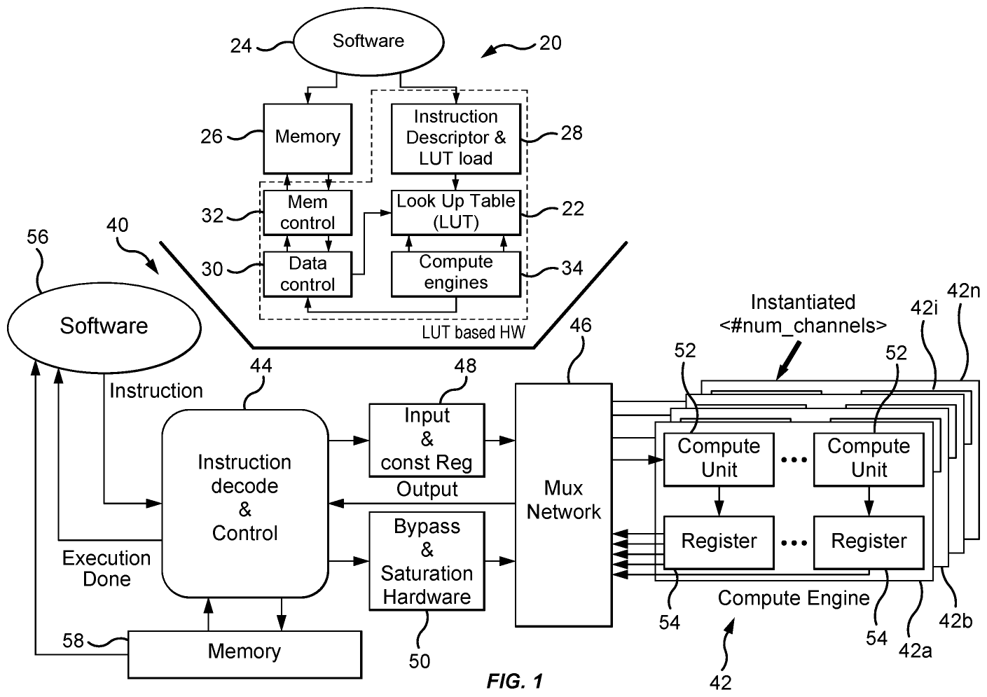

FIG. 1 shows a conventional hardware implementation 20 that uses an LUT 22 to store curve fitting procedure coefficients. More particularly, an activation function curve is bounded between interval [−m,m] (e.g., where “m” is a real number). This bounded curve is divided into a number of segments and curve fitting algorithm coefficients are computed and stored in the LUT 22 (e.g., memory). While performing operations (ax+b) or (ax²+bx+c) for any point on the curve, the values of a, b and c are fetched from the LUT 22 and the expressions are calculated using multipliers and adders. Values beyond the interval are considered for saturation or bypass operations. In the case of saturation logic, the value from the LUT 22 is passed to the output without any modification while in case of bypass logic, the input is passed on to the output without any modification.

The operation begins with software 24 loading the required activation input data to a memory 26 and then based on the targeted activation function, the LUT 22 is loaded through an instruction descriptor and load block 28. This block 28 is also responsible for loading the saturation values. A data control block 30 starts the operations by issuing a read request to the memory 26 through a memory control block 32. Once the input data is read back from the memory 26, the data control block 30 performs two operations on the input: 1) check for saturation/bypass, and 2) if saturation or bypass is not triggered, generate an address in the LUT 22 to fetch the appropriate coefficients. The data fetched from the LUT 22 are fed to compute engines 34, which are capable of handling first and second order polynomial equations. For every activation function change, a new instruction descriptor is programmed by the software 24 and appropriate data may be loaded into the LUT 22 through the instruction descriptor and load block 28.

In general, the conventional hardware implementation 20 may encounter challenges in terms of high storage area. For example, the accuracy of output values depends on the complexity of the activation function and the number of segments used in the computation. Since unit of least precision (ULP) errors (e.g., maximum error that can be encountered when storing a number) are exponentially proportionate to the number of segments, the LUT 22 storage increases significantly with accuracy constraints. Additionally, when ROM (read-only memory) is chosen for an area-efficient implementation, overheads of updating values in the LUT 22 can be significant when multiple activation functions are invoked sequentially (e.g., one after the other). The conventional hardware implementation may also encounter challenges in terms of the location of the LUT 22. For example, if the LUT 22 is not located close to the compute engines 34, the LUT 22 might significantly affect the overall performance due to higher access latency. Moreover, the conventional hardware implementation 20 may encounter challenges with respect to vectorized (e.g., single instruction multiple data/SIMD) execution. For example, sharing the LUT 22 across multiple SIMD channels may require the LUT 22 to be multi-ported. With the addition of each port, the area cost of arbitration and multiplexer structure increases, and point area and power overheads could be substantial.

By contrast, an enhanced hardware accelerator 40 as described herein does not rely on the LUT 22. Rather, the enhanced hardware accelerator 40 includes a compute engine 42 (42a-42n), a controller 44 (e.g., instruction decode and control), a multiplexer (mux, e.g., cross bar connect) network 46, input and constant register files 48, and bypass and saturation hardware 50. The compute engine 42 includes multiple sets of compute planes, wherein each compute plane processes one SIMD channel (e.g., lane) of the input data vector. For example, the illustrated compute plane 42a includes multiple pairs of compute units 52 and tightly coupled output registers 54. Each compute unit 52 can perform a fixed arithmetic operation (e.g., exponentiation, logarithm, multiplication, addition, . . . ) and produce output data value in the corresponding output register 54. Input data from the input and constant register files 48 (e.g., to each compute unit) can be flexibly selected through the mux network 46, which is fully programmable. An input data bus to the mux network 46 is connected to the output registers 54 present in the compute engine 42. Through this programmatic flexibility, compute unit 52 execution can be pipelined in any user-given order to achieve the targeted functionality.

A set of inputs to the mux network 46 are also fed through the input and constant register files 48, which enables feeding the input and constant data to the compute engine 42 as appropriate to evaluate the activation function expression. The output register 54 from the last valid compute unit 52 is routed through the mux network 46 as the final output data vector. The bypass and saturation hardware 50 processes the input data and/or final output data vector for input range checks and output clipping functionality, respectively, as instructed by software 56. The controller 44 is responsible for decoding instructions (e.g., micro-codes) from the software 56, driving select signals of the mux network 46 accordingly, initializing constant registers, sending control signals to the bypass and saturation hardware 50, reading input data values from memory 58, and writing valid output data to the memory 58.

The technology described herein also includes an enhanced instruction set architecture (ISA) to program the hardware and fully control the execution to achieve the targeted functionality. More particularly, a user-given activation function is decomposed into simple arithmetic and fundamental operations, wherein each operation is encoded into a unique instruction (e.g., micro-code) that binds a compute unit 52 to the appropriate input data register in the input and constant register files 48. The mux network 46 includes multiple multiplexer units and each multiplexer unit is associated with a unique compute unit 52. Upon decoding each instruction, select pins of the corresponding multiplexer unit are driven appropriately. Accordingly, through a unique set of micro-code, the software 56 can control the execution on the proposed hardware.

The enhanced hardware accelerator 40 is therefore fully programmable hardware with higher accuracy, power and area efficiency as compared to the LUT based conventional hardware implementation 20. The enhanced hardware accelerator 40 has a scalable design architecture to trade-off between accuracy and area (e.g., no control area overheads with accuracy). The enhanced hardware accelerator 40 is also capable of supporting any complex and/or future activation function and includes a power saving mode by bypassing unutilized compute unit(s) 52.

Moreover, the enhanced hardware accelerator 40 involves minimal programming overhead with merely a few bytes of micro-code as compared to populating the relatively large LUT 22. In addition, the enhanced hardware accelerator 40 has a native ability to achieve instruction level parallelism controlled by the software 56. For example, this parallelism can be achieved when an output register 54 in the compute engine 42 or an input register in the input constant and register files 48 is selected by more than one multiplexer unit. The enhanced hardware accelerator 40 also has the ability to map those activation functions that involve a greater number of compute units 52 (e.g., hardware resource constraint mapping) by re-utilizing constrained compute unit(s) 52 in multi-stage pipelining with the assistance of “move” instructions and lowering throughput (e.g., increasing cycle-per-instructions).

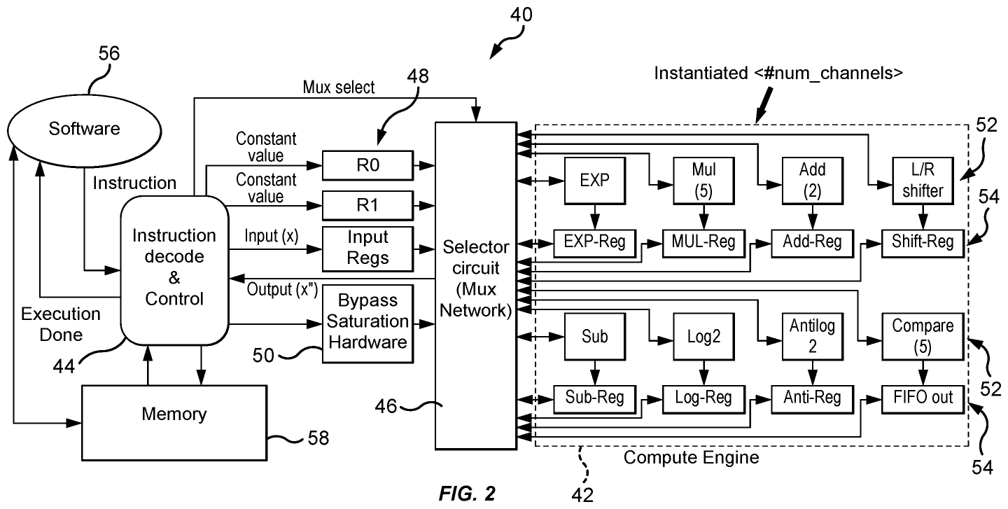

Turning now to FIG. 2, a more detailed view of the enhanced hardware accelerator 40 is shown. As already noted, the enhanced hardware accelerator 40 is fully programmable LUT free hardware to support variety of non-linear functions by using generic compute resources. The mux network 46 (e.g., selector circuit) forms the connections between these generic compute resources to achieve the targeted function. In addition, an ISA instruction is used to drive this hardware and is converted into a unique set of micro-code maintained by the software 56. In an embodiment, the set of micro-code is mapped onto the mux network 46 to realize the targeted activation function. The number of compute resources (e.g., captured in parentheses “( )”) in the compute engine 42 can vary depending on the implementation. In the illustrated example, the compute resources include a comparator, basic arithmetic operators (e.g., five multipliers, two adders, one subtractor) and elementary arithmetic operators (e.g., one exponent operator, one left/right shifter, one binary logarithm operator, and one binary antilogarithm operator). Non-linear activation functions may be mapped using the mux network 46 with any generic compute engine 42 capable of handling the targeted basic functionalities. As will be discussed in greater detail, a limitation of the resources may result in the micro-code generated for the realization of non-linear activation functions being executed in sequential order whenever there is a contention for the same resources (e.g., by generating a dependency signal and clearing the dependency signal once executed).

In one example, operation begins with the software 56 programing the hardware through an instruction based on the ISA proposed herein. The software 56 may maintain a set of micro-code for each of the defined activation functions. Once the instruction is decoded and a corresponding set of micro-code is fetched by the controller 44 from the memory 58, the controller 44 translates the micro-codes into a set of control signals to configure the hardware through the mux network 46. The controller 44 is also responsible for generating input addresses and reading the inputs from the memory 58, generating output addresses, and writing the output of the hardware back to the memory 58. In an embodiment, the controller 44 also programs the constant values in two dedicated registers (e.g., “R0” and “R1”) of the input and constant register files 48.

Based on the arguments presented in the instruction, the controller 44 also loads bypass region settings and saturation region settings. These values are used when the current input falls beyond the range of the activation function under consideration. The comparator within the compute engine 42 keeps track of such scenarios and once triggered, the comparator reads the values from the bypass and saturation hardware 50 and writes those values to a FIFO (first in first out) output buffer. The contents of the FIFO output buffer are eventually written back to the memory 58. In one example, all compute resources within the compute engine 42 are connected to the mux network 46 through a selector circuit. The output of each resource is stored in a respective temporary register and connected to the mux network 46 as a feedback path to the other resources.

The mux network 46 may include a set of multiplexer circuits (e.g., one multiplexer circuit per compute resource input), which can decide on what input to be fed to the resource and where to route the output from the resource. This approach provides a high number of options to configure the available resources and realize a large set of activation functions and their respective first order derivatives. As already noted, the illustrated configuration includes five instances of multipliers (“Mul”), two instances of adders (“Add”) and one instance of each exponent (“Exp), binary logarithm (“Log 2”), binary antilogarithm (“Antilog 2”), subtractor (“Sub”), comparator (“Compare”) and shifter (“IR shifter”). Multiple compute engines 42 can be instantiated to obtain multiple channels running in parallel without scaling the mux network 46 or the controller 44. This approach provides the flexibility to scale the hardware for higher throughput without increasing the area linearly.

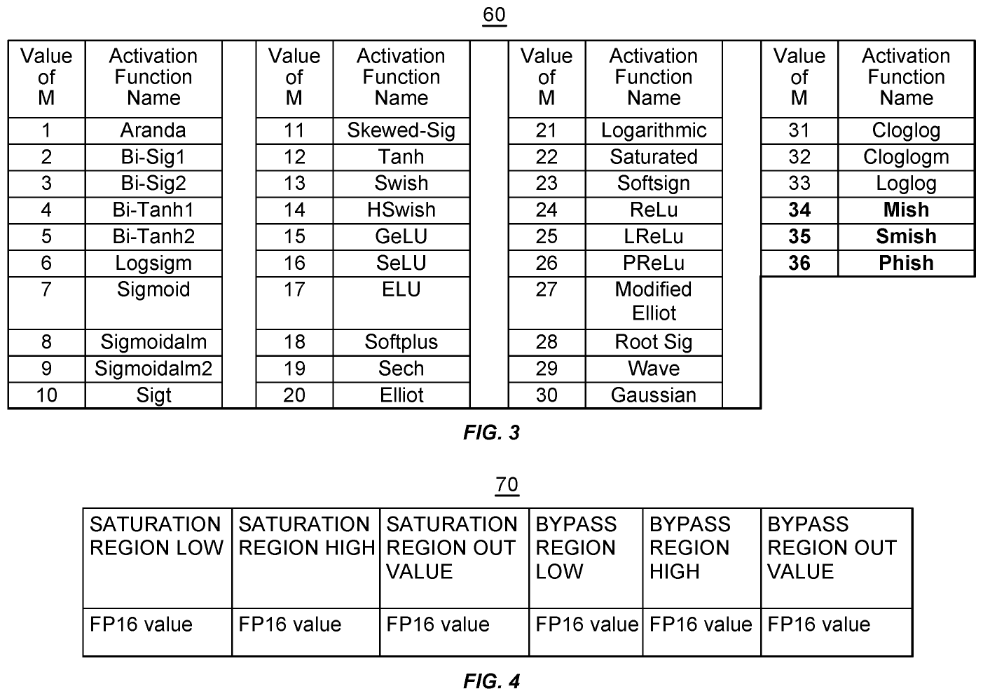

FIG. 3 shows a table 60 (e.g., data structure) of activation functions that can be conducted via an ISA instruction as described herein. In the illustrated example, the new instruction is: ACTMN, activation function of “M” type in “N” order, where M is a variable indicating a type of activation function to be executed and N indicates whether to execute the original activation function or the first order derivative of the original activation function. The variable M can take any value from the supported activation function table 60, while variable N can take the value of either zero (e.g., for original M function) or one (e.g., for first order derivative of M function). For example, to execute the sigmoid activation function, the given instruction can be generated as: ACT70, while for the first order derivative of the sigmoid activation function, the given instruction can be generated as: ACT71.

The format of the new instruction with arguments is: ACTMN tdest, tsrc1, tsrc2, #immediate, where tdest holds the output base address (e.g., output address) to the memory where non-linear functions output will be written back, tsrc1 holds the base address of the input data (e.g., input address) in the memory, tsrc2 holds the bypass and saturation address (e.g., address in the memory where description about the saturation and bypass table are stored), and #immediate indicates the number of input activations for which the activation functions will be processed. Thus, #3 indicates that there are three input activations to the activation function. In one example, the software populates these details at the appropriate location in the architecture.

The table 60 can be extended or updated to support future or a different set of activation functions. For each activation function in the table 60, the software maintains a set of micro-code that is consumed by the proposed hardware to configure the mux network for realization of the activation function.

FIG. 4 shows a table 70 of bypass region settings (e.g., bypass region low, bypass region high, bypass region out) and saturation region settings (e.g., saturation region low, saturation region high, saturation region out). In an embodiment, the table 70 is stored in the memory at the region specified by the tsrc2 argument. Additionally, the table 70 can be different for each activation function.

### Saturation Region Settings

If the activation function or the derivative of the activation function has a saturation region on either the positive or the negative side of the input data range, then the technology described herein provides the flexibility to specify the upper limit (SATURATION REGION HIGH), the lower limit of saturation region (SATURATION REGION LOW), and a corresponding output value (SATURATION REGION OUT VALUE) in the saturation region.

### Bypass Region Settings

If the activation function or the derivative of the activation function has a bypass region on either the positive or the negative side of the input data range, then, technology described herein provides the flexibility to specify the upper limit (BYPASS REGION HIGH) and lower limit (BYPASS REGION LOW) of bypass region and a corresponding output value (BYPASS REGION OUT VALUE) in the bypass region. In one example, a value of “32′d0” implies that the targeted equation does not have a bypass region. For more than one saturation/bypass region, the fields of bypass/saturation regions can be reused to indicate a second saturation/bypass region.

### Multiplexer Network

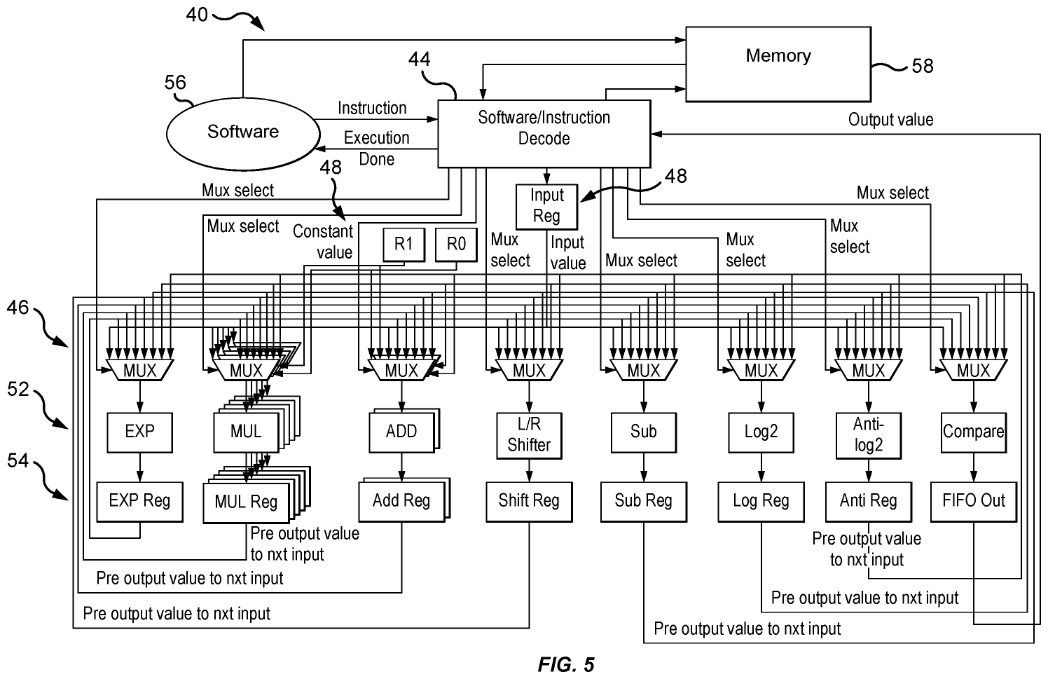

FIG. 5 shows a more detailed example of the multiplexer network 46. The illustrated example includes one mux circuit per compute resource input. In an embodiment, there can be two types of inputs to the mux circuit, 1) a value from any of the previous outputs or 2) a value directly from an input register in the input and constant register files 48. For multiplier and adder operators, an extra set of inputs provide constant values from R0 and R1. Based on the details programmed in the ISA instruction, the controller 44 fetches a unique set of micro-code maintained by the software 56 for each activation function. The fetched micro-codes are translated directly into the select values/pins of the mux network 46 and the order of the micro-code does not impact the realization of the activation function. Any stage can be bypassed (e.g., no operation/NOP) by setting the mux circuit in the default mode.

All thirty-six activation functions listed in the table 60 (FIG. 3) can be mapped to the proposed hardware through the mux network 46 by corresponding micro-code. Extending the solution for future functions can support the following scenarios: 1) some functions might have different sets of micro-code but produce the same output, 2) some functions may share a portion of micro-codes with other functions.

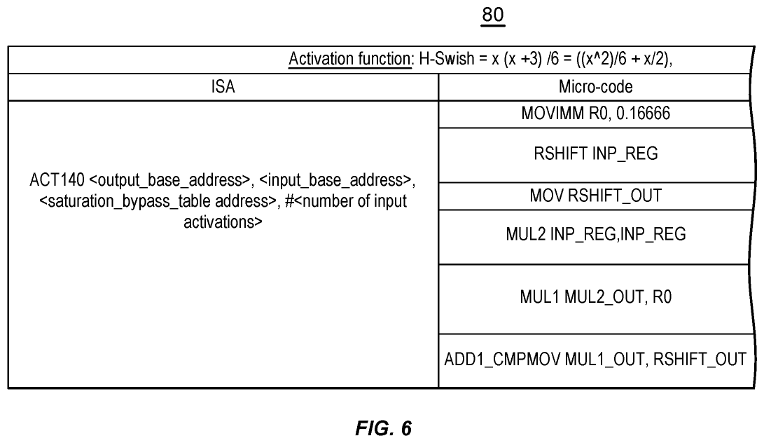

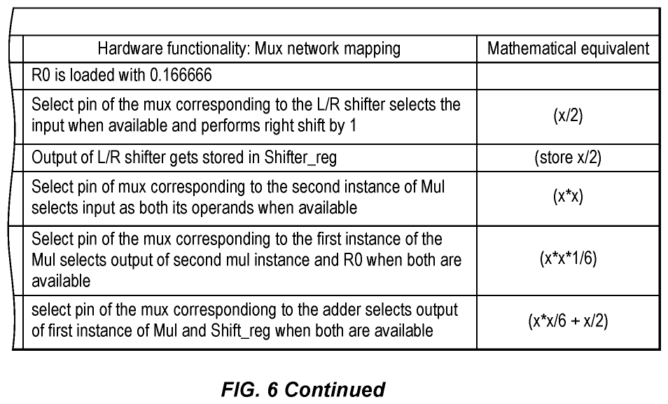

FIG. 6 shows a table 80 of micro-codes for a hard swish (H-Swish) activation function with the hardware functionality and equivalent mathematical equation. The illustrated micro-code loads an R0 constant value and triggers connections between shift, multiply and add operators. In an embodiment, the micro-code of the table 80 is stored in a memory such as, for example, the memory 58 (FIGS. 1, 2, 5), already discussed.

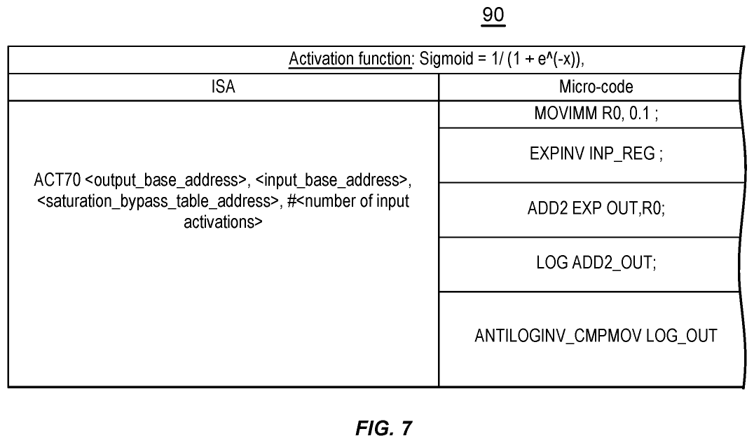

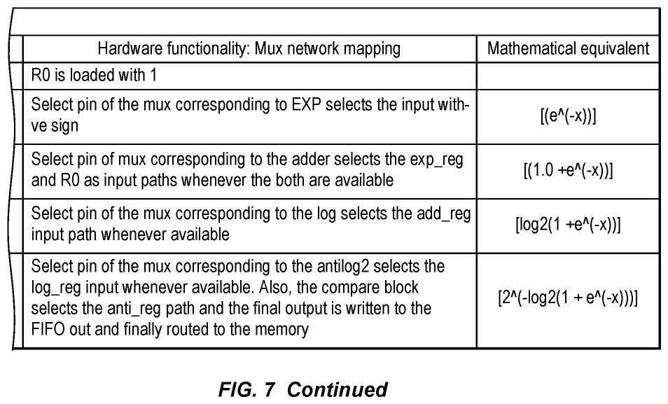

FIG. 7 shows a table 90 of micro-codes for a sigmoid activation function with the hardware functionality and equivalent mathematical equation. The illustrated micro-code loads an R0 constant value and triggers connections between exponent, add, logarithmic and antilogarithmic operators. In an embodiment, the micro-code of the table 90 is stored in a memory such as, for example, the memory 58 (FIGS. 1, 2, 5), already discussed.

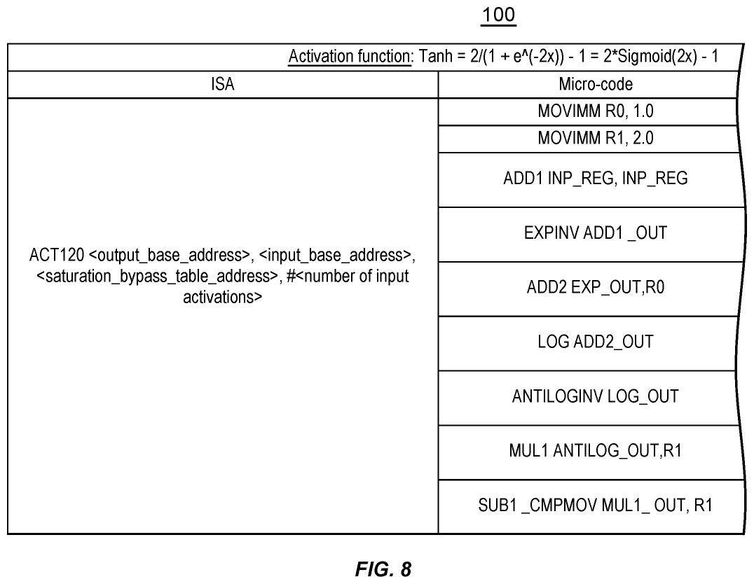

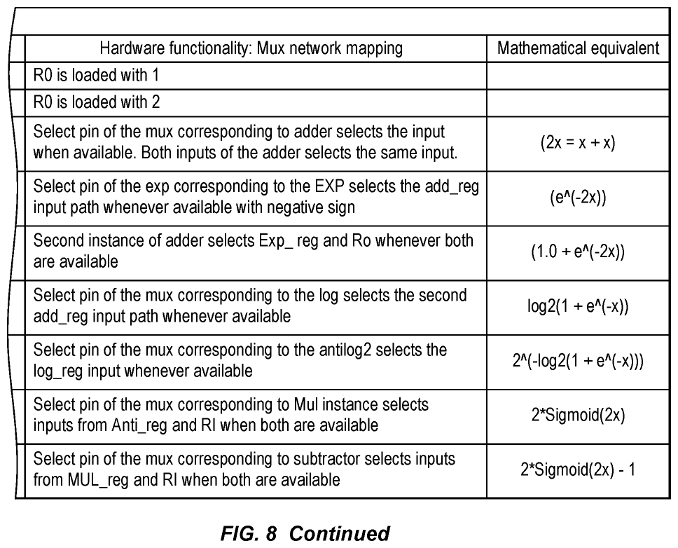

FIG. 8 shows a table 100 of micro-codes for a hyperbolic tangent activation function with the hardware functionality and equivalent mathematical equation. The illustrated micro-code loads R0 and R1 constant values and triggers connections between add, exponent, logarithmic, antilogarithmic, multiply and subtract operators. In an embodiment, the micro-code of the table 100 is stored in a memory such as, for example, the memory 58 (FIGS. 1, 2, 5), already discussed. In one example, the memory is multi-ported to support the storage and retrieval of multiple sets of micro-code in parallel (e.g., reducing latency).

### Bypass and Saturation

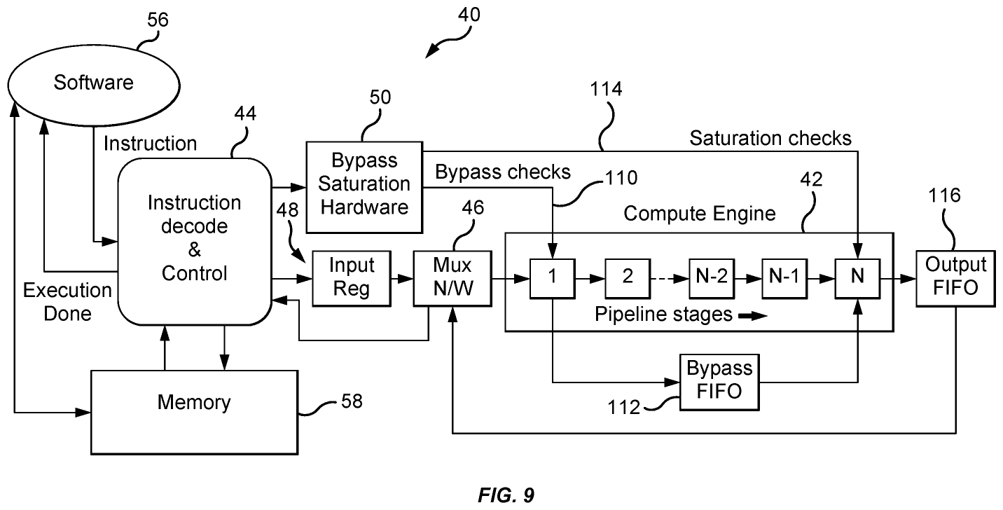

Turning now to FIG. 9, variable latency in bypass and saturation regions of activation functions may be handled in the hardware as follows. Bypass checks 110 are performed by the bypass and saturation hardware 50 on the input against the bypass region of the activation function at the beginning of the compute phase. Using a bypass FIFO 112, the bypass input is removed from the main execution pipeline. Similarly, saturation checks 114 are performed by the bypass and saturation hardware 50 on the output computed until the (N−1)^{th} stage of the compute pipeline against the pre-defined saturation level. In cases where the threshold is breached, the output of (N−1)^{th} stage is dropped and the saturation value is obtained directly from the pre-defined value.

More particularly, stage one of the compute pipeline checks the input for a bypass condition by comparing against the bypass check 1112 (e.g., the bypass value programmed by the software for a particular activation function). If the input is found to fall in the bypass region, the value of the input is moved to a bypass FIFO 112. To make the outputs in-order the input is read back from the bypass FIFO 112 at the last stage of the pipeline and written to an output FIFO 116. During the entire operation, the compute pipeline is not occupied by the bypass input with NOPs enabling the other valid inputs to propagate by moving the bypass input to the bypass FIFO 112.

For saturation, Stage N of the compute pipeline checks the output of (N−1)^{th} stage against the saturation check 114 (e.g., the saturation threshold value programmed by the software for that activation function). If the input value to stage N breaches the saturation threshold, a pre-determined saturation value is written to the output FIFO 116 instead of the Stage N output and the output of Stage (N−1) is dropped.

### Resource Contention

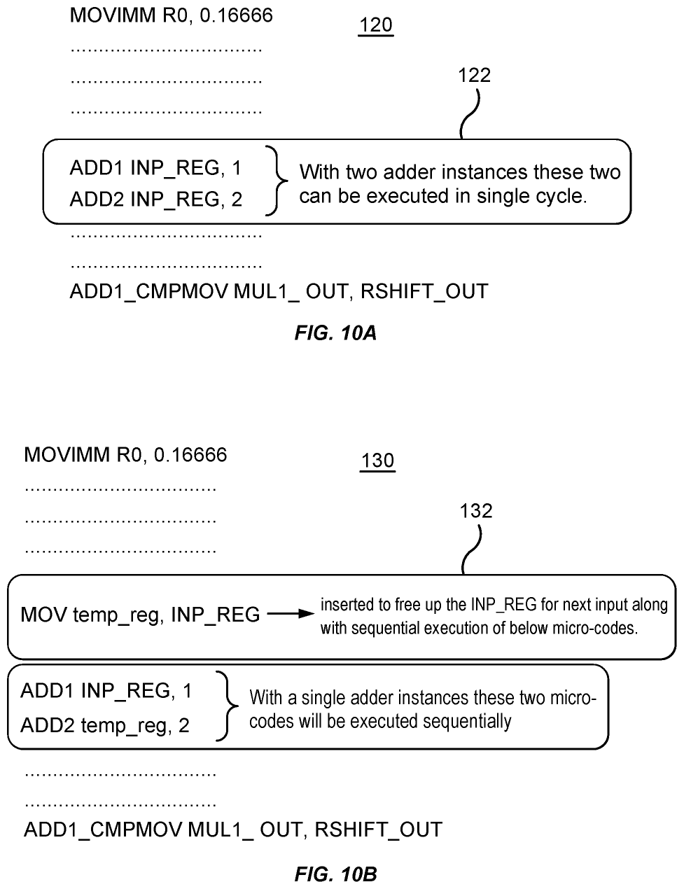

FIG. 10A shows a parallel instruction sequence 120 for a situation in which there are two micro-codes 122 that trigger an addition operation. The two micro-codes 122 are independent because the respective addition operations are performed on the input data without involving the output of any previous stage to be fed back as an input. If sufficient resources are available in the hardware, the two micro-codes 122 are executed in a single cycle (e.g., in parallel).

FIG. 10B shows a sequential instruction sequence 130 for situations when the number of targeted operations is greater than the available compute resources (e.g., the hardware sequentially executes the remaining micro-codes/operations if there is only one adder instance). More particularly, the modified micro-code generated by the instruction decode provides hardware with a number of extra operations to perform the activation function with the available resources. Using this information, hardware keeps track of the status flags internally. With the insertion of a new move (“mov”) command 132, an INP_REG register is freed up to load the next input. In the case where there is a contention (e.g., a newer operator also involves the same resource) the hardware sets a dependency flag/bit that will stall the execution of the newer operation. This dependency bit is cleared by the hardware once the earlier operation is finished and the newer operation is permitted to execute.

### Switching Between Different Activation Functions

In one example, switching between activation functions is permitted only after the entire compute pipeline is finished with the current work and hardware sends an “execution_done” signal back to the software. This constraint may avoid any data corruption due to the switching of the activation function.

In situations where the software schedules a subsequent function before the completion of the previous function, the controller can scan for the complete change in the micro-codes and set a hazardous execution flag. In such cases, the controller prevents the newer function from being scheduled and corrupting the inflight operations.

There are several ways that this scan can be implemented. In one approach, the entire micro-coded sequence can be read out in parallel, with the micro-codes being stored in a set of registers. This set of registers can be then compared with any following sequence in its entirety, and a contention can be detected. For example, the micro-code that is operating may have the registers shifted with each instruction, so that only the remaining instructions will be checked.

### Simultaneous Execution of Multiple Activation Functions

In situations where two or more functions that share an initial common portion of micro-codes, are to be executed on the same set of input data, micro-codes corresponding to one of the functions is loaded first (e.g., configuring the mux network accordingly), while partial micro-codes for other function(s) are cached into a local storage (e.g., ROM, registers). During the execution of the first loaded function, intermediate data values (e.g., output values from the common portions of micro-codes) are stored into internal registers (or memory). After the execution of the first function, partial micro-codes (e.g., un-executed) of other function(s) are loaded sequentially (e.g., re-configuring the mux network accordingly), with execution being conducted on intermediate data values and the output values being computed.

This approach helps in avoiding re-computation for common portions of micro-codes if multiple functions are executed on the same set of inputs. In cases where the activation functions are to operate over different sets of inputs, each function is fully executed sequentially (e.g., one after the another) as in the case of the sequential instruction sequence 130 (FIG. 10B).

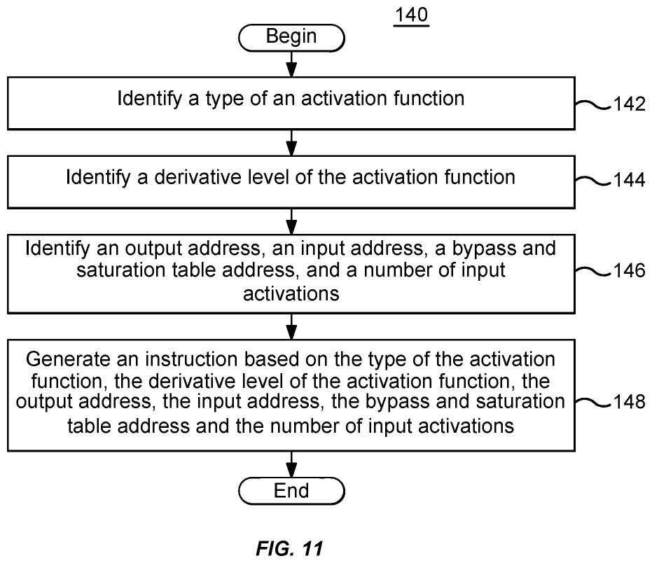

FIG. 11 shows a method 140 of issuing activation function instructions. The method 140 may generally be implemented in software such as, for example, the software 56 (FIGS. 1, 2, 5 and 9), already discussed. More particularly, the method 140 may be implemented in one or more modules as a set of logic instructions (e.g., executable program instructions) stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Illustrated processing block 142 provides for identifying a type of an activation function. In an embodiment, block 142 identifies one of the types of activation functions listed in the table 60 (FIG. 3). Block 144 identifies a derivative level (e.g., original function/0^{th} order, 1^{st} order) of the activation function. Block 146 may identify an output address, an input address, a bypass and saturation table address, and a number of input activations. In one example, block 148 generates an instruction based on the type of the activation function, the derivative level of the activation function, the output address, the input address, the bypass and saturation table address and the number of input activations. As already noted, the format of the instruction may be “ACTMN tdest, tsrc1, tsrc2, #immediate” and the instruction may be an ISA instruction.

The method 140 therefore enhances performance at least to the extent that generating the instruction based on the type and derivative level the activation function enables decode operations to avoid the detailed numerical analysis associated with LUT based solutions. The method 140 also improves scalability by eliminating the control overhead associated with LUT based solutions and increases accuracy relative to approximation solutions.

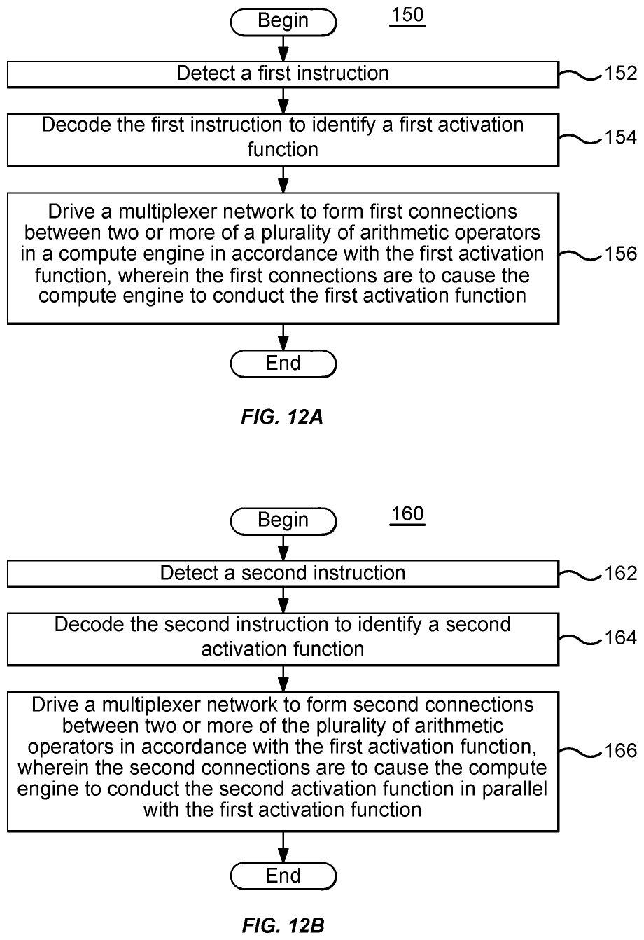

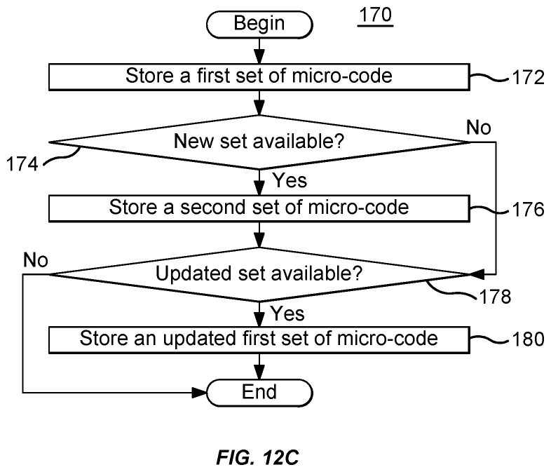

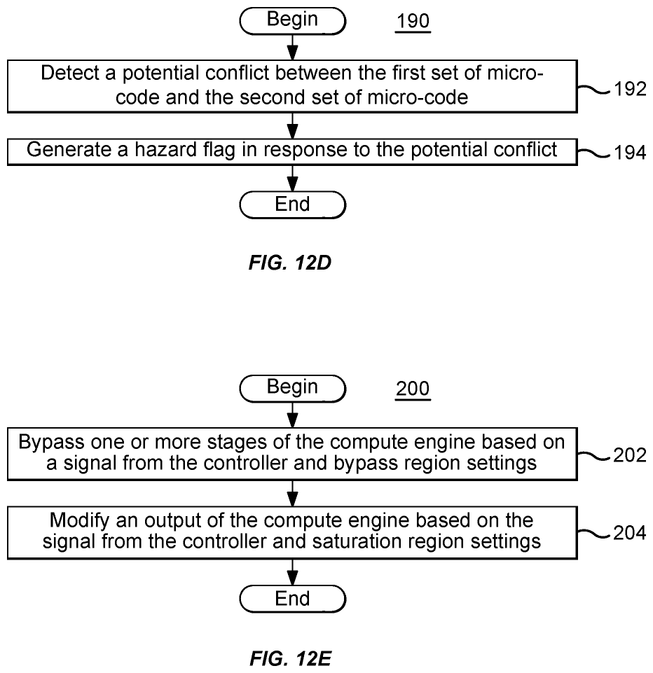

FIG. 12A shows a method 150 of handling activation function instructions. The method 150 may generally be implemented in conjunction with the method 140 (FIG. 11) in a semiconductor apparatus including a controller such as, for example, the controller 44 (FIGS. 1, 2, 5, 9), already discussed. More particularly, the method 150 may be implemented in one or more modules as a set of logic instructions stored in a machine- or computer-readable storage medium such as RAM, ROM, PROM, firmware, flash memory, etc., in hardware, or any combination thereof.

Illustrated processing block 152 provides for detecting a first instruction. In one example, the first instruction is an ISA instruction generated in accordance with the method 140 (FIG. 11), already discussed. Block 154 decodes the first instruction to identify a first activation function. In an embodiment, block 154 also decodes the first instruction to identify a derivative level of the first activation function, an output address, an input address, a bypass and saturation table address and/or a number of input activations. Block 156 drives a multiplexer network to form first connections between two or more of a plurality of arithmetic operators in a compute engine in accordance with the first activation function, wherein the first connections are to cause the compute engine to conduct the first activation function.

In one example, the controller is coupled to a memory such as, for example, the memory 58 (FIGS. 1, 2, 5, 9), already discussed, wherein the memory stores a first set of micro-code. In such a case, block 156 may include driving the multiplexer network based on the first set of micro-code to form the first connections. Block 156 may also retrieve the first set of micro-code entirely prior to driving the multiplexer network to form the first connections. Such an approach enables the controller to detect potential conflicts between sets of micro-code.

In an embodiment, block 156 drives the multiplexer network to form third connections between two or more of the plurality of arithmetic operators in accordance with the first activation function. In such a case, the third connections cause the compute engine to conduct the first activation function and the third connections are different from the first connections (e.g., different micro-coded sequences result in the same output).

In one example, the plurality of arithmetic operators include basic arithmetic operators (e.g., multipliers, adders, subtractors) and/or elementary arithmetic operators (e.g., exponent, shifter, binary logarithm, and binary antilogarithm). The compute engine may also include a plurality of registers corresponding to the plurality of arithmetic operators, wherein the plurality of registers store outputs of the plurality of arithmetic operators. In an embodiment, one or more of the outputs include intermediate results.

The method 150 therefore enhances performance at least to the extent that driving the multiplexer network to form connections between arithmetic operators avoids the detailed numerical analysis associated with LUT based solutions. The method 150 also improves scalability by eliminating the control overhead associated with LUT based solutions and increases accuracy relative to approximation solutions.

FIG. 12B shows another method 160 of handling activation function instructions. The method 160 may generally be implemented in conjunction with the method 140 (FIG. 11) and/or the method 150 (FIG. 12A) in a semiconductor apparatus including a controller such as, for example, the controller 44 (FIGS. 1, 2, 5, 9), already discussed. More particularly, the method 160 may be implemented in one or more modules as a set of logic instructions stored in a machine- or computer-readable storage medium such as RAM, ROM, PROM, firmware, flash memory, etc., in hardware, or any combination thereof.

Illustrated processing block 162 provides for detecting a second instruction. In one example, the second instruction is an ISA instruction generated in accordance with the method 140 (FIG. 11), already discussed. Block 164 decodes the second instruction to identify a second activation function. In an embodiment, block 164 also decodes the second instruction to identify a derivative level of the second activation function, an output address, an input address, a bypass and saturation table address and/or a number of input activations. Block 166 drives a multiplexer network to form second connections between two or more of a plurality of arithmetic operators in the compute engine in accordance with the second activation function, wherein the second connections are to cause the compute engine to conduct the second activation function. In the illustrated example, the first activation function and the second activation function are conducted in parallel. The method 160 therefore further enhances performance at least to the extent that conducting activation functions in parallel reduces latency.

FIG. 12C shows a method 170 of operating a memory device. The method 170 may generally be implemented in conjunction with the method 140 (FIG. 11), the method 150 (FIG. 12A) and/or the method 160 (FIG. 12B) in a memory device including a memory such as, for example, the memory 58 (FIGS. 1, 2, 5, 9), already discussed. More particularly, the method 170 may be implemented in one or more modules as a set of logic instructions stored in a machine- or computer-readable storage medium such as RAM, ROM, PROM, firmware, flash memory, etc., in hardware, or any combination thereof.

Illustrated processing block 172 provides for storing a first set of micro-code to the memory. As already noted, the controller can drive the multiplexer network based on the first set of micro-code to form the first connections, which in turn cause the compute engine to conduct the first activation function. A determination is made at block 174 as to whether a new set of micro-code is available (e.g., for the second activation function). If so, block 176 stores a second set of micro-code to the memory, wherein the controller drives the multiplexer network based on the second set of micro-code to form the second connections and the second connections cause the compute engine to conduct the second activation function. Block 178 determines whether an updated first set of micro-code is available. If so, block 180 stores the updated first set of micro-code to the memory. If it is determined at block 174 that a new set of micro-code is not available, the method 170 bypasses block 176. Similarly, if it is determined at block 178 that an updated first set of micro-code is not available, the method 170 bypasses block 180. In one example, the memory is multi-ported to support the storage and retrieval of multiple sets of micro-code in parallel. Such an approach further reduces latency.

FIG. 12D shows a method 190 of handling potential conflicts between sets of micro-code. The method 190 may generally be implemented in conjunction with the method 140 (FIG. 11), the method 150 (FIG. 12A), the method 160 (FIG. 12B) and/or the method 170 (FIG. 12C) in a semiconductor apparatus including a controller such as, for example, the controller 44 (FIGS. 1, 2, 5, 9), already discussed. More particularly, the method 190 may be implemented in one or more modules as a set of logic instructions stored in a machine- or computer-readable storage medium such as RAM, ROM, PROM, firmware, flash memory, etc., in hardware, or any combination thereof.

Illustrated processing block 192 provides for detecting a potential conflict between the first set of micro-code and the second set of micro-code. In one example, block 192 includes maintaining the entire sequence of the first set of micro-code in a first set of registers, maintaining the entire sequence of the second set of micro-code in a second set of registers, comparing the first set of registers with the second set of registers (e.g., offset by the difference in issue time), and identifying a resource that is predicted to be requested by both sets of micro-code at the same time. Block 194 generates a hazard flag in response to the potential conflict.

FIG. 12E shows a method 200 of operating bypass hardware and saturation hardware. The method 200 may generally be implemented in conjunction with the method 140 (FIG. 11), the method 150 (FIG. 12A), the method 160 (FIG. 12B), the method 170 (FIG. 12C) and/or the method 190 (FIG. 12D) in a semiconductor apparatus including bypass and saturation hardware such as, for example, the bypass and saturation hardware 50 (FIGS. 1, 2, 9), already discussed. More particularly, the method 200 may be implemented in one or more modules as a set of logic instructions stored in a machine- or computer-readable storage medium such as RAM, ROM, PROM, firmware, flash memory, etc., in hardware, or any combination thereof.

Illustrated processing block 202 provides for bypassing one or more stages of the compute engine based on a signal from the controller and bypass region settings. Block 204 modifies an output of the compute engine based on the signal from the controller and saturation region settings.

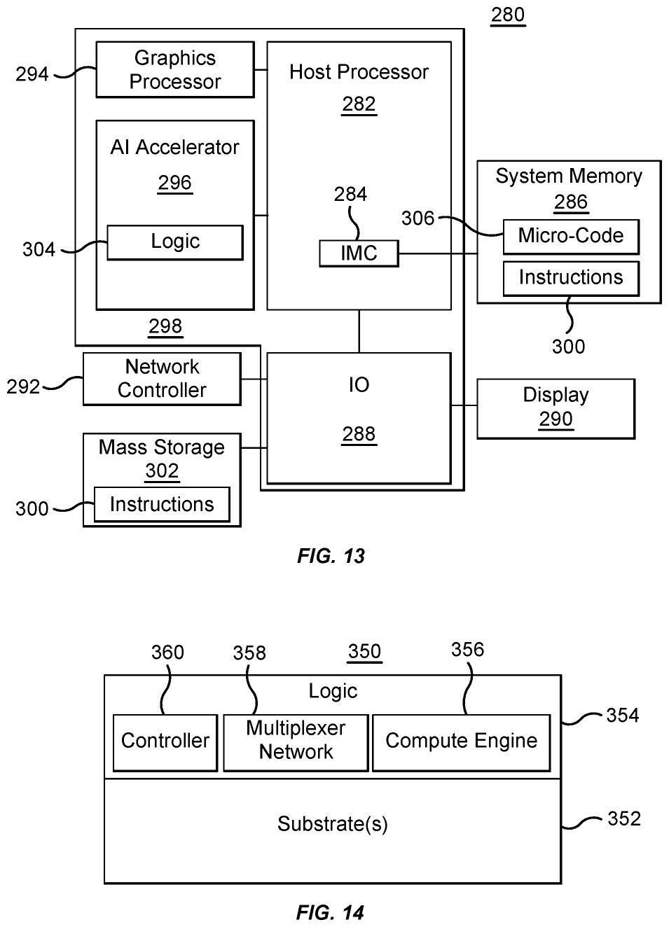

Turning now to FIG. 13, a performance-enhanced computing system 280 is shown. The system 280 may generally be part of an electronic device/platform having computing functionality (e.g., personal digital assistant/PDA, notebook computer, tablet computer, convertible tablet, edge node, server, cloud computing infrastructure), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, drone functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM including a plurality of DRAMs). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an artificial intelligence (AI) accelerator 296 (e.g., specialized processor) into a system on chip (SoC) 298. In an embodiment, the AI accelerator 296 includes the enhanced hardware accelerator 40 (FIGS. 1, 2, 5, 9), already discussed.

The host processor 282 retrieves executable program instructions 300 from the system memory 286 and/or the mass storage 302 and executes the instructions 300 to perform one or more aspects of the method 140 (FIG. 11), already discussed. Thus, execution of the instructions 300 by the host processor 282 causes the host processor 282 and/or the computing system 280 to identify a type of a first activation function, identify a derivative level of the first activation function, and generate a first instruction based on the type of the first activation function and the derivative level of the first activation function.

The illustrated AI accelerator includes logic 304 to perform one or more aspects of the method 150 (FIG. 12A), the method 160 (FIG. 12B), the method 170 (FIG. 12C), the method 190 (FIG. 12D) and/or the method 200 (FIG. 12E), already discussed. Thus, the logic 304 includes a compute engine including a plurality of arithmetic operators, a multiplexer network coupled to the compute engine, and a controller coupled to the multiplexer network. The controller detects the first instruction, decodes the first instruction to identify the first activation function, and drives the multiplexer network to form first connections between two or more of the plurality of arithmetic operators in accordance with the first activation function. The first connections cause the compute engine to conduct the first activation function. Additionally, the system memory 286 may store a first set of micro-code 306, wherein the controller drives the multiplexer network based on the first set of micro-code 306 to form the first connections.

The computing system 280 is therefore considered to be performance-enhanced at least to the extent that driving the multiplexer network to form connections between arithmetic operators avoids the detailed numerical analysis associated with LUT based solutions. The computing system 280 also improves scalability by eliminating the control overhead associated with LUT based solutions and increases accuracy relative to approximation solutions.

FIG. 14 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. The logic 354 can be readily substituted for the logic 304 (FIG. 13), already discussed. In an embodiment, the logic 354 implements one or more aspects of the method 150 (FIG. 12A), the method 160 (FIG. 12B), the method 170 (FIG. 12C), the method 190 (FIG. 12D) and/or the method 200 (FIG. 12E), already discussed. Thus, the logic 354 includes a compute engine 356 having a plurality of arithmetic operators (e.g., basic arithmetic operators, elementary arithmetic operators), a multiplexer network 358 coupled to the compute engine 356, and a controller 360 coupled to the multiplexer network 358. During operation, the controller 360 detects a first instruction, decodes the first instruction to identify a first activation function, and drives the multiplexer network 358 to form first connections between two or more of the plurality of arithmetic operators in accordance with the first activation function. As already noted, the first connections cause the compute engine 356 to conduct the first activation function.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

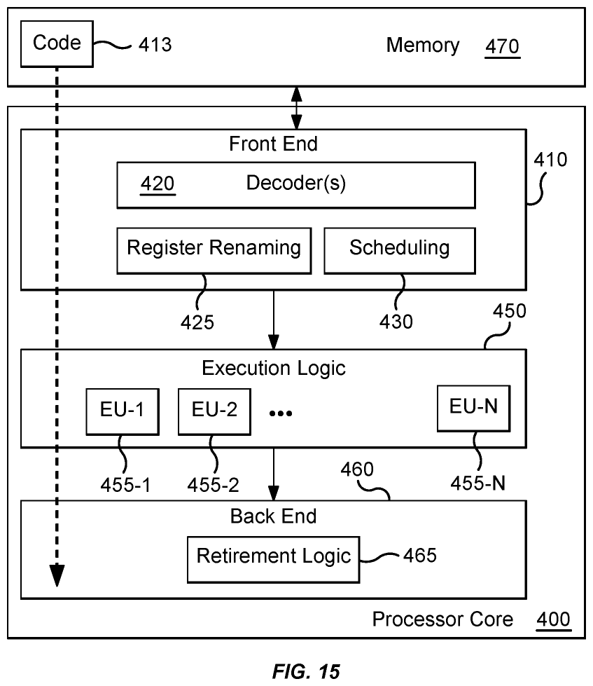

FIG. 15 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 15, a processing element may alternatively include more than one of the processor core 400 illustrated in FIG. 15. The processor core 400 may be a single-threaded core or, for at least one embodiment, the processor core 400 may be multithreaded in that it may include more than one hardware thread context (or “logical processor”) per core.

FIG. 15 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 140 (FIG. 11), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 15, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

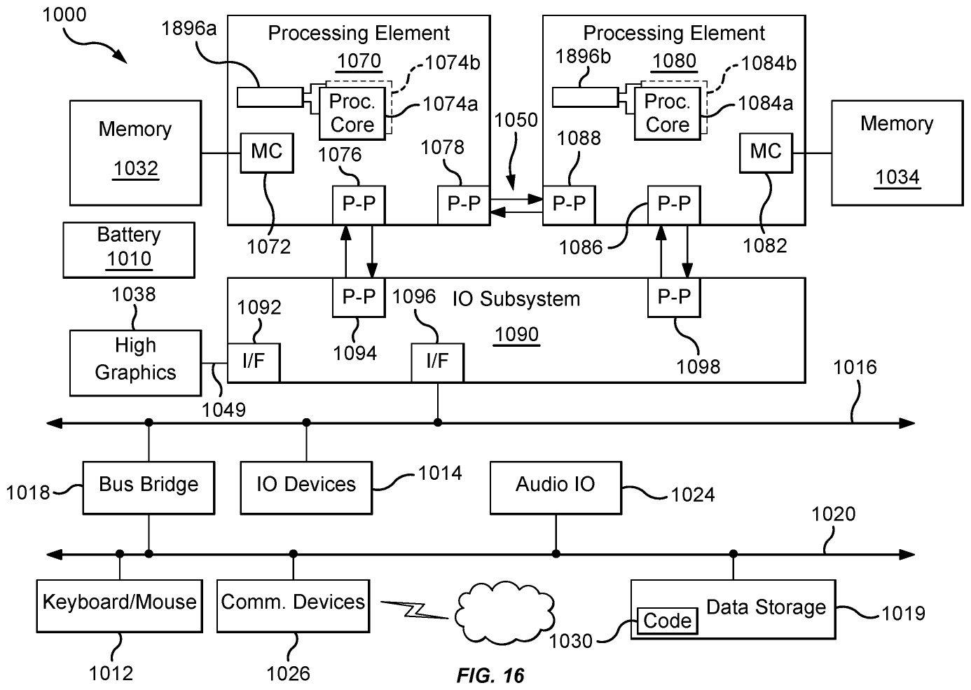

Referring now to FIG. 16, shown is a block diagram of a computing system 1000 embodiment in accordance with an embodiment. Shown in FIG. 16 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 16 may be implemented as a multi-drop bus rather than point-to-point interconnect.

As shown in FIG. 16, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 15.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 16, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 16, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 16, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 140 (FIG. 11), already discussed. Further, an audio I/O 1024 may be coupled to second bus 1020 and a battery 1010 may supply power to the computing system 1000.

Note that other embodiments are contemplated. For example, instead of the point-to-point architecture of FIG. 16, a system may implement a multi-drop bus or another such communication topology. Also, the elements of FIG. 16 may alternatively be partitioned using more or fewer integrated chips than shown in FIG. 16.

### Additional Notes and Examples

Example 1 includes a performance-enhanced computing system comprising a processor, a system memory coupled to the processor, wherein the system memory includes one or more executable program instructions, which when executed by the processor, cause the processor to generate a first instruction associated with a first activation function, and an accelerator including logic coupled to one or more substrates, the logic including a compute engine including a plurality of arithmetic operators, a multiplexer network coupled to the compute engine, and a controller coupled to the multiplexer network, the controller to detect the first instruction, decode the first instruction to identify the first activation function, and drive the multiplexer network to form first connections between two or more of the plurality of arithmetic operators in accordance with the first activation function, wherein the first connections are to cause the compute engine to conduct the first activation function.

Example 2 includes the computing system of Example 1, wherein the one or more executable program instructions, when executed, further cause the processor to identify a type of a first activation function and identify a derivative level of the first activation function, wherein the first instruction is generated based on the type of the first activation function and the derivative level of the first activation function.

Example 3 includes the computing system of Example 1, wherein the controller is further to detect a second instruction, decode the second instruction to identify a second activation function, and drive the multiplexer network to form second connections between two or more of the plurality of arithmetic operators in accordance with the second activation function, wherein the second connections are to cause the compute engine to conduct second activation function, and wherein the first activation function and the second activation function are conducted in parallel.

Example 4 includes a semiconductor apparatus comprising one or more substrates, and logic coupled to the one or more substrates, wherein the logic is implemented at least partly in one or more of configurable or fixed-functionality hardware, the logic including a compute engine including a plurality of arithmetic operators, a multiplexer network coupled to the compute engine, and a controller coupled to the multiplexer network, the controller to detect a first instruction, decode the first instruction to identify a first activation function, and drive the multiplexer network to form first connections between two or more of the plurality of arithmetic operators in accordance with the first activation function, wherein the first connections are to cause the compute engine to conduct the first activation function.

Example 5 includes the semiconductor apparatus of Example 4, wherein the controller is further to detect a second instruction, decode the second instruction to identify a second activation function, and drive the multiplexer network to form second connections between two or more of the plurality of arithmetic operators in accordance with the second activation function, wherein the second connections are to cause the compute engine to conduct the second activation function, and wherein the first activation function and the second activation function are conducted in parallel.

Example 6 includes the semiconductor apparatus of Example 4, wherein the controller is further to drive the multiplexer network to form third connections between two or more of the plurality of arithmetic operators in accordance with the first activation function, wherein the third connections are to cause the compute engine to conduct the first activation function and the third connections are different from the first connections.

Example 7 includes the semiconductor apparatus of Example 4, further including a memory coupled to the controller, the memory to store a first set of micro-code, wherein the controller drives the multiplexer network based on the first set of micro-code to form the first connections.

Example 8 includes the semiconductor apparatus of Example 7, wherein the memory is multi-ported.

Example 9 includes the semiconductor apparatus of Example 7, wherein the memory is to store an updated first set of micro-code.

Example 10 includes the semiconductor apparatus of Example 7, wherein the memory is to store a second set of micro-code, and wherein the controller is to drive the multiplexer network based on the second set of micro-code to form second connections between two or more of the plurality of arithmetic operators in accordance with a second activation function.

Example 11 includes the semiconductor apparatus of Example 10, wherein the controller is further to detect a potential conflict between the first set of micro-code and the second set of micro-code, and generate a hazard flag in response to the potential conflict.

Example 12 includes the semiconductor apparatus of Example 7, wherein the controller is further to retrieve the first set of micro-code entirely prior to driving the multiplexer network to form the first connections.

Example 13 includes the semiconductor apparatus of Example 4, wherein the compute engine further includes a plurality of registers corresponding to the plurality of arithmetic operators, and wherein the plurality of registers are to store outputs of the plurality of arithmetic operators.

Example 14 includes the semiconductor apparatus of Example 13, wherein the outputs are to include intermediate results.

Example 15 includes the semiconductor apparatus of any one of Examples 4 to 14, wherein the logic further includes bypass hardware coupled to the controller and the compute engine, the bypass hardware to bypass one or more stages of the compute engine based on a signal from the controller and bypass region settings, and saturation hardware coupled to the controller and the compute engine, the saturation hardware to modify an output of the compute engine based on the signal from the controller and saturation region settings.

Example 16 includes the semiconductor apparatus of Example 4, wherein the plurality of arithmetic operators include basic arithmetic operators and elementary arithmetic operators.

Example 17 includes the semiconductor apparatus of Example 4, wherein the logic coupled to the one or more substrates includes transistor channel regions that are positioned within the one or more substrates.

Example 18 includes at least one computer readable storage medium comprising a one or more executable program instructions, which when executed by a computing system, cause the computing system to identify a type of an activation function, identify a derivative level of the activation function, and generate an instruction based on the type of the activation function and the derivative level of the activation function.

Example 19 includes the at least one computer readable storage medium of Example 18, wherein the one or more executable program instructions, when executed, further cause the computing system to identify an output address, identify an input address, identify a bypass and saturation table address, identify a number of input activations, wherein the instruction is generated further based on the output address, the input address, the bypass and saturation table address, and the number of input activations.

Example 20 includes the at least one computer readable storage medium of any one of Examples 18 to 19, wherein the instruction is an instruction set architecture instruction.

Example 21 includes a method of operating a performance-enhanced computing system, the method comprising detecting a first instruction, decoding the first instruction to identify a first activation function, and driving the multiplexer network to form first connections between two or more of a plurality of arithmetic operators in accordance with the first activation function, wherein the first connections are to cause a compute engine to conduct the first activation function.

Example 22 includes a method of operating a performance-enhanced computing system, the method comprising identifying a type of an activation function, identifying a derivative level of the activation function, and generating an instruction based on the type of the activation function and the derivative level of the activation function.

Example 23 includes means for performing the method of any one of Examples 21 to 22.

The technology described herein improves future readiness, re-configurability and/or extensibility because any activation function/first order derivative of activation function can be expressed in terms of basic functions such as exponent, multiplication, addition, log/antilog etc. Such an approach helps to quickly realize activation functions in terms of ISA/micro-code for a given hardware (e.g., unlike LUT, where detailed numerical analysis is conducted regarding the number of segments and interpolation coefficients).

The technology described also improves scalability because control can be amortized over multiple instances of an activation function pipeline and the ratio of data path area to control path area is skewed towards data path. The result is a scalable solution (e.g., unlike LUT solutions, which result in significant control overhead).

The technology described herein also improves accuracy because the proposed hardware accuracy is comparable to LUT based solutions and better than approximation based approach.

Considering the wide variety of activation functions/first order derivatives of activation functions, embodiments advantageously provide a unified hardware-software co-design solution, which can be used for both training and inferences. With neural network models evolving at a fast pace, the technology described herein is flexible/configurable with respect to newly developed activation functions and datatype/precision. The configurable hardware-software solution described herein does not compromise on accuracy/throughput, while keeping a low cost of area. By conducting computation in non-saturation/non-bypass region for every activation function, the technology described herein saves significant area and power. Embodiments also do not involve significant data transfers (e.g., unlike LUT, which involves data transfers for re-programming), and results in power/bandwidth savings. This hardware-software solution can be used as a plug and play solution for all convolutional neural network/recurrent neural network workloads.

Embodiments may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a processor,
a system memory coupled to the processor, wherein the system memory includes one or more executable program instructions, which when executed by the processor, cause the processor to generate a first instruction associated with a first activation function; and
an accelerator including logic coupled to one or more substrates, the logic including:
a compute engine including a plurality of arithmetic operators,
a multiplexer network coupled to the compute engine, and
a controller coupled to the multiplexer network, the controller to:
detect the first instruction,
decode the first instruction to identify the first activation function, and
drive the multiplexer network to form first connections between two or more of the plurality of arithmetic operators in accordance with the first activation function, wherein the first connections are to cause the compute engine to conduct the first activation function.

2. The computing system of claim 1, wherein the one or more executable program instructions, when executed, further cause the processor to:
identify a type of the first activation function; and
identify a derivative level of the first activation function, wherein the first instruction is generated based on the type and the derivative level of the first activation function.

3. The computing system of claim 1, wherein the controller is further to:
detect a second instruction,
decode the second instruction to identify a second activation function, and
drive the multiplexer network to form second connections between two or more of the plurality of arithmetic operators in accordance with the second activation function, wherein the second connections are to cause the compute engine to conduct second activation function, and wherein the first activation function and the second activation function are conducted in parallel.

4. A semiconductor apparatus comprising:
one or more substrates; and
logic coupled to the one or more substrates, wherein the logic is implemented at least partly in one or more of configurable or fixed-functionality hardware, the logic including:
a compute engine including a plurality of arithmetic operators;
a multiplexer network coupled to the compute engine; and
a controller coupled to the multiplexer network, the controller to:
detect a first instruction,
decode the first instruction to identify a first activation function, and
drive the multiplexer network to form first connections between two or more of the plurality of arithmetic operators in accordance with the first activation function, wherein the first connections are to cause the compute engine to conduct the first activation function.

5. The semiconductor apparatus of claim 4, wherein the controller is further to:
detect a second instruction,
decode the second instruction to identify a second activation function, and
drive the multiplexer network to form second connections between two or more of the plurality of arithmetic operators in accordance with the second activation function, wherein the second connections are to cause the compute engine to conduct the second activation function, and wherein the first activation function and the second activation function are conducted in parallel.

6. The semiconductor apparatus of claim 4, wherein the controller is further to drive the multiplexer network to form third connections between two or more of the plurality of arithmetic operators in accordance with the first activation function, wherein the third connections are to cause the compute engine to conduct the first activation function and the third connections are different from the first connections.

7. The semiconductor apparatus of claim 4, further including a memory coupled to the controller, the memory to store a first set of micro-code, wherein the controller drives the multiplexer network based on the first set of micro-code to form the first connections.

8. The semiconductor apparatus of claim 7, wherein the memory is multi-ported.

9. The semiconductor apparatus of claim 7, wherein the memory is to store an updated first set of micro-code.

10. The semiconductor apparatus of claim 7, wherein the memory is to store a second set of micro-code, and wherein the controller is to drive the multiplexer network based on the second set of micro-code to form second connections between two or more of the plurality of arithmetic operators in accordance with a second activation function.

11. The semiconductor apparatus of claim 10, wherein the controller is further to:
detect a potential conflict between the first set of micro-code and the second set of micro-code, and
generate a hazard flag in response to the potential conflict.

12. The semiconductor apparatus of claim 7, wherein the controller is further to retrieve the first set of micro-code entirely prior to driving the multiplexer network to form the first connections.

13. The semiconductor apparatus of claim 4, wherein the compute engine further includes a plurality of registers corresponding to the plurality of arithmetic operators, and wherein the plurality of registers are to store outputs of the plurality of arithmetic operators.

14. The semiconductor apparatus of claim 13, wherein the outputs are to include intermediate results.

15. The semiconductor apparatus of claim 4, wherein the logic further includes:
bypass hardware coupled to the controller and the compute engine, the bypass hardware to bypass one or more stages of the compute engine based on a signal from the controller and bypass region settings; and
saturation hardware coupled to the controller and the compute engine, the saturation hardware to modify an output of the compute engine based on the signal from the controller and saturation region settings.

16. The semiconductor apparatus of claim 4, wherein the plurality of arithmetic operators include basic arithmetic operators and elementary arithmetic operators.

17. The semiconductor apparatus of claim 4, wherein the logic coupled to the one or more substrates includes transistor channel regions that are positioned within the one or more substrates.

18. At least one computer readable storage medium comprising one or more executable program instructions, which when executed by a computing system, cause the computing system to:
identify a type of an activation function;
identify a derivative level of the activation function; and
generate an instruction based on the type of the activation function and the derivative level of the activation function.

19. The at least one computer readable storage medium of claim 18, wherein the one or more executable program instructions, when executed, further cause the computing system to:
identify an output address;
identify an input address;
identify a bypass and saturation table address;
identify a number of input activations, wherein the instruction is generated further based on the output address, the input address, the bypass and saturation table address, and the number of input activations.

20. The at least one computer readable storage medium of claim 18, wherein the instruction is an instruction set architecture instruction.
